(19) United States
(12) Patent Application Publication
(10) Pub. No.: US 2006/0282973 A1
(43) Pub. Date: Dec. 21, 2006

(54) Windshield wiper structure

(76) Inventor: Chi-Sheng Chang, Taipei (TW)

Correspondence Address: Chi-Sheng Chang, 20525 Via Talavera, Yorba Linda, CA, 92887, US

(21) Appl. No.: 11/449,367

(22) Filed: Jun. 9, 2006

(30) Foreign Application Priority Data
Jun. 20, 2005 (TW) 094210347

(51) Int. Cl. B60S 1/38

(52) U.S. Cl. 15/250.201; 15/250.43

(57) ABSTRACT

The present invention discloses an improved windshield wiper structure that includes a wiper arm having a latch disposed at the middle of the wiper arm, a wiper blade integrally fixed with the wiper arm; two auxiliary plates disposed on both left and right sides of the latch on the wiper arm respectively, and two fixing members for integrally fixing the wiper arm, wiper blade and auxiliary plates, so as to increase the pressure of attaching a windshield wiper onto a windshield and enhance the structural stability of the windshield wiper.

### FIELD OF THE INVENTION

The present invention relates to a windshield wiper structure, and more particularly to an improved windshield wiper structure that can increase the pressure of attaching a wiper onto a windshield and enhance the structural stability of the windshield wiper.

### BACKGROUND OF THE INVENTION

Referring to FIG. 1 for the structure of a prior art windshield wiper 1, the windshield wiper 1 is comprised of a wiper arm 11, a latch 12, a wiper blade 13 and two fixing members 14, wherein the wiper arm 11 has a penetrating slot 111 disposed at the middle of the wiper arm 11 for passing a protrusion 131 disposed at the upper edge of the wiper blade 13 through the penetrating slot 111 and operates together with two fixing members 14 to fix the wiper blade 13 with the wiper arm 11, so as to increase the stability of the wiper arm 11 and the wiper blade 13. Referring to FIG. 2 for the structure of another prior art windshield wiper 2, the windshield wiper 2 is comprised of a wiper arm 21, a latch 22, a wiper blade 23 and two fixing members 24, wherein the wiper arm 21 has a penetrating slot 211 disposed at the middle of the wiper arm 21 for passing a protrusion 231 disposed at an upper edge of the wiper blade 23 through the penetrating slot 211 and an opening 212 disposed separately on both ends of the penetrating slot 211 for facilitating the installation or removal of the protrusion 231 disposed on the upper edge of the wiper blade 23 with the penetrating slot 211 disposed at the middle of the wiper arm 21. Further, the wiper arm 21 is operated with two fixing members 24, and the wiper arm 21 can be fixed integrally with the wiper blade 23, so as to increase the stability of connecting the wiper arm 21 and the wiper blade 23.

However, the aforementioned prior art windshield wiper structures have the following shortcomings:

1. The pressure of attaching the wiper onto the windshield is insufficient, so that streaks will remain on the windshield. The latches 12, 22 are latched integrally with the support frame of the automobile windshield wiper motor and the windshield wiper motor is used to drive the windshield wiper for wiping rain water away from the windshield. However, the wiper blade 13, 23 of the windshield wiper will have some gaps produced after the windshield wiper has been used for a period of time, such that when the rain water is wiped, the rain water will pass through these gaps and remain on the windshield, and thus creating an unclear vision to drivers and causing potential risks to drivers.

2. The structure of windshield is unstable and may be loosened easily. Since the wiper blade 13, 23 is connected to the wiper arm 11, 21 by the fixing members 14, 24 only, the wiper blade 13, 23 may be exhausted or deformed easily after being used for some time, therefore the fixing member 14, 24 will no longer remain tightly fixed, and the whole windshield wiper will be loosened and cannot be used anymore.

3. It is difficult to change wiper blades 23. When the wiper blade 23 is installed, the wiper blade 23 is passed vertically downward through the opening 212 of the wiper arm 21 and then the wiper blade 23 is pressed downward, so that when the protrusion 231 of the wiper blade 23 is passed into the penetrating slot 211 and pressed vertically downward through the wiper arm 21 to fix the protrusion 231 and the penetrating slot 211, the wiper blade 23 may get stuck at the opening 212, and thus making the installation procedure difficult.

In view of the shortcomings of the aforementioned windshield wiper structures, the inventor of the present invention based on years of experience in the related industry to conduct extensive researches and experiments, and finally developed an improved windshield wiper structure that utilizes a simple design to increase the pressure of attaching the wiper onto a windshield and enhance the structural stability of the windshield wiper.

### SUMMARY OF THE INVENTION

Therefore, it is a primary objective of the present invention to design an improved windshield wiper structure that can increase the pressure of attaching a wiper onto a windshield.

Another objective of the present invention is to design an improved windshield wiper structure that can enhance the structural stability of a windshield wiper.

To achieve the foregoing objectives, the present invention adopts the technical measures as follows:

An improved windshield wiper structure comprises: a wiper arm having a latch installed at the middle of the wiper arm; a wiper blade fixed integrally with the wiper arm; two auxiliary plates disposed on both left and right sides of the latch on the wiper arm respectively; and two fixing members for integrally fixing the wiper arm, the wiper blade and the auxiliary plates to increase the pressure of attaching the wiper onto a windshield and enhance the structural stability of the windshield wiper.

The above and other objects, features and advantages of the present invention will become apparent from the following detailed description taken with the accompanying drawing.

### BRIEF DESCRIPTION OF THE DRAWINGS

FIG. 1 is an exploded view of a prior art structure;

FIG. 2 is an exploded view of another prior art structure;

FIG. 3 is an exploded view of the structure of the present invention;

FIG. 4 is a schematic view of an assembly of the present invention;

FIG. 5 is a transversal cross-sectional view of the present invention; and

FIG. 6 is a longitudinal cross-sectional view of the present invention.

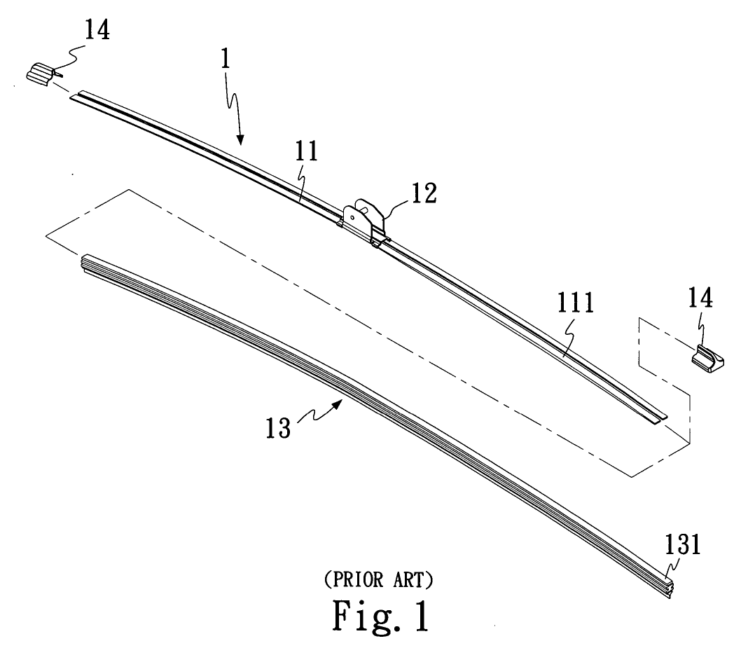

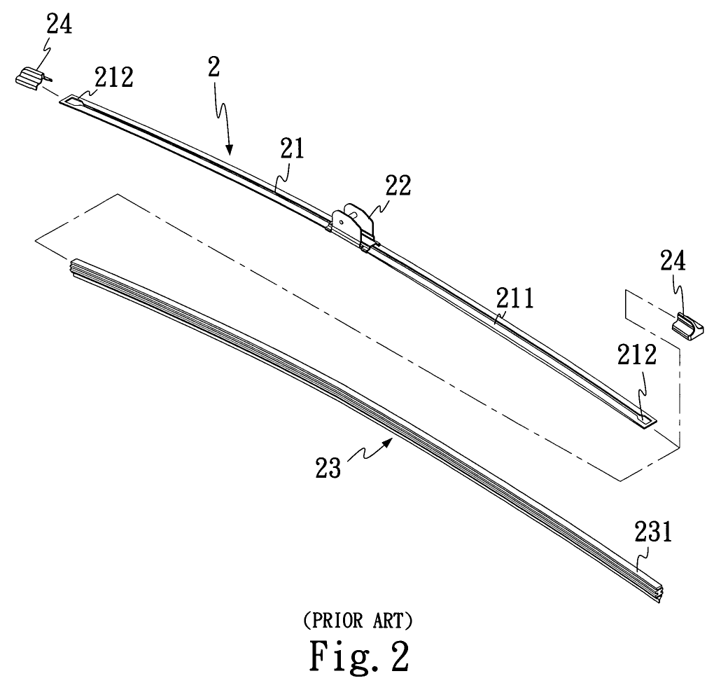

### DETAILED DESCRIPTION OF THE PREFERRED EMBODIMENTS

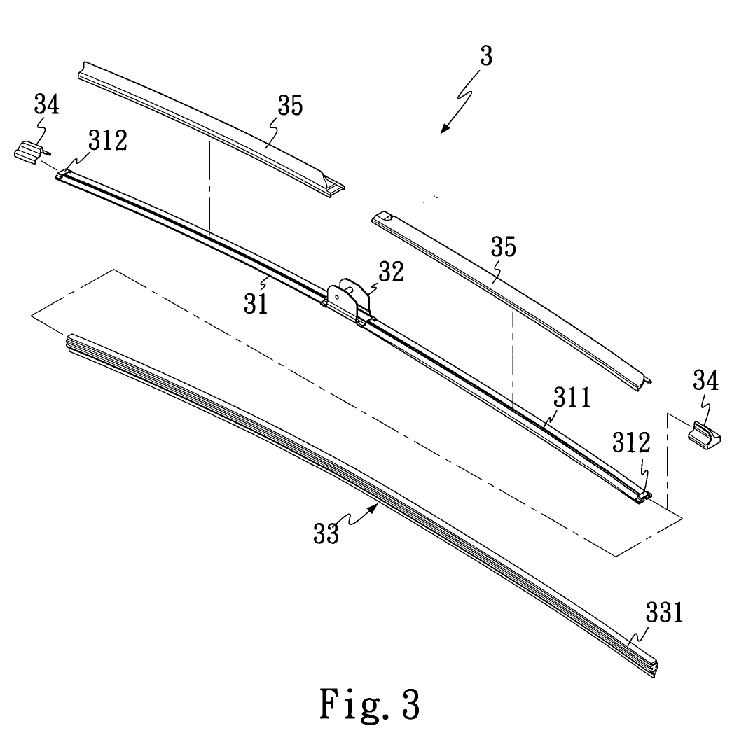

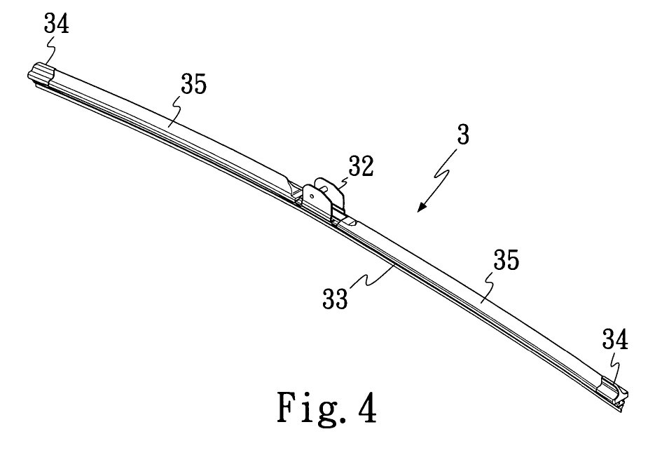

Referring to FIGS. 3 and 4 for the exploded view and the schematic view of the structure of the present invention, an improved windshield wiper 3 structure comprises: a wiper arm 31 having a penetrating slot 311 disposed at the middle of the wiper arm 31 and a latch 32 disposed on the wiper arm 31, such that the latch 32 is latched integrally with a support frame of an automobile windshield wiper motor, and the windshield wiper motor is provided for driving the windshield wiper 3 to move; a wiper blade 33 for wiping rain water away from an automobile windshield and having a protrusion 331 disposed on an upper edge of the wiper blade 33 and passed through a penetrating slot 311 disposed at the middle of the wiper arm 31, such that the wiper blade 33 and its protrusion 331 are disposed on both upper and lower surfaces of the wiper arm 31 respectively to integrally fix the wiper blade 33 with the wiper arm 31; two auxiliary plates 35 disposed on both left and right sides of the latch 32 on the wiper arm 31; and two fixing members 34 for integrally fixing the wiper arm 31, wiper blade 33 and auxiliary plates 34. The wiper arm 31 includes an n-shape member 312 disposed separately on both ends of the wiper arm 31, such that the protrusion 331 of the wiper blade 33 can pass through the opening at the middle of the n-shape member 312 regardless of the protrusion 331 being passed through or removed from the penetrating slot 311 of the wiper arm 31, and thus making the installation very convenient. When it is necessary to change the wiper blade 33, users simply need to remove the fixing member 34 at either side of the wiper arm 31 and draw the wiper blade 33 out. If it is necessary to install a wiper blade 33, users simply pass the protrusion 331 disposed on the wiper blade 33 into the n-shape member 312 disposed on the wiper arm 31, such that the n-shape member 312 and the wiper arm 31 disposed at upper and lower positions can guide the wiper blade 33 into the penetrating slot 311 of the wiper arm 31 easily to achieve the effect of a quick change of wiper blades 33.

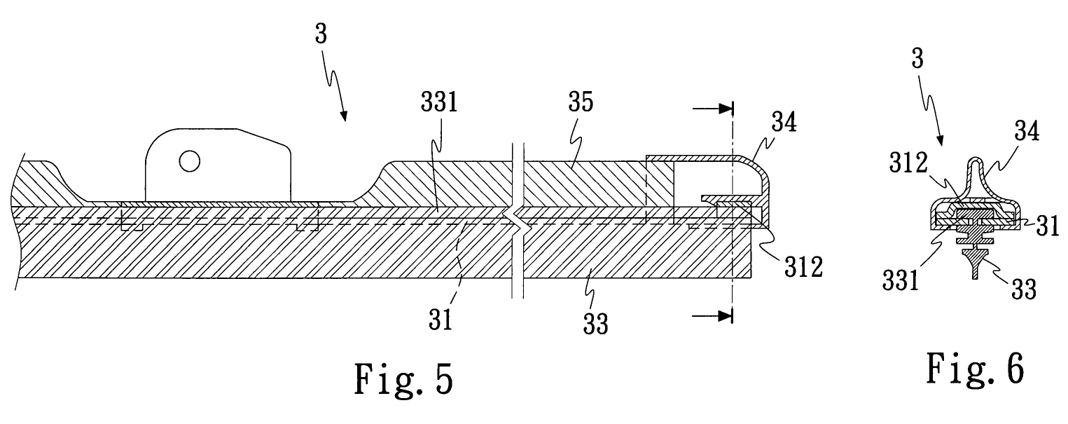

Referring to FIGS. 5 and 6 for the transversal and longitudinal cross-sectional views of the present invention, the structural assembly of the windshield wiper 3 passes the protrusion 331 disposed at the top edge of the wiper blade 33 through the penetrating slot 311 disposed at the middle of the wiper arm 31, such that the wiper blade 33 and its protrusion 331 are disposed separately on the upper and lower surfaces of the wiper arm 31, and an auxiliary plate 35 corresponding to the shape of the protrusion 331 and the wiper arm 31 is installed, and the fixing members 34 are used to integrally fix the wiper arm 31, wiper blade 33 and auxiliary plates 35. With the design of the auxiliary plates 35, the weight and pressure of the windshield wiper are increased, so that even if there are gaps produced at the wiper blade 33 after the windshield wiper has been used for some time, the increased weight and pressure of the auxiliary plate 35 still can wipe away the rain water thoroughly. Further, the design of the n-shape member 312 is used to prevent the protrusion 331 of the wiper blade 33 from being in a direct contact with the fixing member 34. Even if the wiper blade 33 is elastically exhausted or deformed after the windshield wiper has been used for some time, the structure of the window wiper will not be loosened easily. The design of the n-shape member 312 and the fixing member 34 provides many contact surfaces, such as an upper surface and two distal surfaces of the n-shape member 312 to increase the friction with the fixing member 34, and the top edge of the auxiliary plate 35 is in contact with the internal surface of the fixing member 34 to increase the friction with the fixing member 34, and thus the overall structure will become stronger and will not be loosened easily due to the frictions, and the structural stability of the windshield wiper 3 will be enhanced.

By the design and installation of the auxiliary plates 35 and the n-shape members 312, the pressure of the windshield wiper for attaching the wiper onto the windshield is increased, and the structural stability of the windshield wiper is enhanced.

In summation of the description above, the improved windshield wiper structure of the present invention effectively overcomes the shortcomings of the prior art, enhances the performance over the conventional structure and complies with the patent application requirements.

What is claimed is:

1. An improved windshield wiper structure, comprising:
a wiper arm, having a latch installed at the middle of said wiper arm;
a wiper blade, fixed integrally with said wiper arm;
two auxiliary plates, disposed on both left and right sides of said latch on said wiper arm respectively; and
two fixing members, for integrally fixing said wiper arm, said wiper blade and said auxiliary plates.

2. The improved windshield wiper structure of claim 1, wherein said wiper arm has a penetrating slot disposed at the middle of said wiper arm.

3. The improved windshield wiper structure of claim 1, wherein said wiper blade has a protrusion disposed at an upper edge of said wiper blade.

4. The improved windshield wiper structure of claim 1, wherein said wiper arm has an n-shape member disposed separately on both ends of wiper arm.
